(19) United States
(12) Patent Application Publication
(10) Pub. No.: US 2010/0152329 A1
(43) Pub. Date: Jun. 17, 2010

(54) POLY(TRIMETHYLENE TEREPHTHALATE) POLYMER BLENDS THAT HAVE REDUCED WHITENING

(75) Inventors: BRETT COLLIN DOBRICK, Wilmington, DE (US); Benjamin Weaver Messmore, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/639,263

(22) Filed: Dec. 16, 2009

Related U.S. Application Data
(60) Provisional application No. 61/138,315, filed on Dec. 17, 2008.

(51) Int. Cl. C08J 3/22; C08L 67/02; C08K 3/04; C08K 3/40

(52) U.S. Cl. 523/351; 524/601

(57) ABSTRACT

The present invention relates to a composition being poly(trimethylene terephthalate) and at least one blend polymer. The invention further includes a process of producing reduced-whitening in articles made from the poly(trimethylene terephthalate) and at least one blend polymer.

### FIELD OF THE INVENTION

The present invention relates to a process of producing non-whitening molded parts of poly(trimethylene terephthalate) (PTT) blends.

### BACKGROUND

The phenomenon of “blooming” is a common problem for polymeric materials. Incompatible materials added to polymers can migrate to the surface of the part, causing a “bloom” or “haze.” These defects have a negative effect on the cosmetic appearance of the material and sometimes can impact performance of the material. In polyester technology, blooming is a well researched phenomenon in polyester films and fibers, namely polyethylene terephthalate (PET) and polytrimethylene terephthalate (PTT). In the case of these polyesters the bloom is not an additive, but thermodynamic by-products of step polymerizations: cyclic oligomers.

Cyclic oligomers exist at equilibrium during the melt polymerization process of polyesters. During the polymerization process, hydroxyl end groups back-bite onto the main polymer chain to form cyclic species. The melt equilibrium of cyclic oligomers in PTT is higher than the melt equilibrium of cyclic oligomers in PET or PBT. The most abundant cyclic oligomer of PTT, PTT cyclic dimer, exists at an equilibrium concentration of 2.5 wt. %. During elevated temperature aging tests, cyclic oligomers of PTT are known to bloom to the surface of molded parts.

Therefore, there is a need for a process for producing non-whitening PTT based polymers. The present invention fills such need.

### SUMMARY OF THE INVENTION

The invention is directed to a process for producing reduced-whitening poly(trimethylene terephthalate)-based polymers, comprising:

combining poly(trimethylene terephthalate) with one or more blend polymers; and

optionally adding one or more pigments;

optionally one or more additives; and

wherein the poly(trimethylene terephthalate)-based polymer exhibits whitening at levels below that of poly(trimethylene terephthalate) when subjected to an elevated temperature aging test.

The invention is further directed to a process for determining L* whiteness of a polymer part comprising poly(trimethylene terephthalate), comprising

a. combining poly(trimethylene terephthalate) with one or more blend polymers;

b. optionally adding one or more pigments;

c. forming a part from said polymer blend;

d. exposing said part to an elevated temperature source at temperatures greater than 100 degrees C. for a period of time of 24 hours or greater;

e. measuring said L* whiteness of said polymer part.

### BRIEF DESCRIPTION OF THE DRAWINGS

FIG. 1 is a graphical representation of the measured level of whiteness of articles made from the polymers described herein versus the percent poly(trimethylene terephthalate) present in the polymers.

### DETAILED DESCRIPTION

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless otherwise stated, all percentages, parts, ratios, etc., are by weight.

Poly(trimethylene terephthalate Component

As indicated above, the polymer component (and composition as a whole) comprises a predominant amount of a poly(trimethylene terephthalate)(PTT).

Poly(trimethylene terephthalate) suitable for use in the invention are well known in the art, and conveniently prepared by polycondensation of 1,3-propane diol with terephthalic acid or terephthalic acid equivalent. It is considered a condensation polymer.

By “terephthalic acid equivalent” is meant compounds that perform substantially like terephthalic acids in reaction with polymeric glycols and diols, as would be generally recognized by a person of ordinary skill in the relevant art. Terephthalic acid equivalents for the purpose of the present invention include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of poly(trimethylene terephthalate) are discussed, for example in U.S. Pat. No. 6,277,947, U.S. Pat. No. 6,326,456, U.S. Pat. No. 6,657,044, U.S. Pat. No. 6,353,062, U.S. Pat. No. 6,538,076, US2003/0220465A1 and commonly owned U.S. patent application Ser. No. 11/638,919 (filed 14 Dec. 2006, entitled “Continuous Process for Producing Poly(trimethylene Terephthalate)”) which are all incorporated by reference.

The 1,3-propanediol for use in making the poly(trimethylene terephthalate) is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including previously incorporated U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The polytrimethylene terephthalate based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴0), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material) f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “6¹³C” values are in parts per thousand (per mil), abbreviated ‰, and are calculated as follows:

$${δ}^{13} C ≡ \frac{( {}^{13} C / {}^{12} C ) sample - ( {}^{13} C / {}^{12} C ) standard}{( {}^{13} C / {}^{12} C ) standard} \times {1000}^{0 {/}_{00}}$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making poly(trimethylene terephthalate) will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1 which are all incorporated by reference.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

Poly(trimethylene terephthalate)s useful in this invention can be poly(trimethylene terephthalate) homopolymers (derived substantially from 1,3-propane diol and terephthalic acid and/or equivalent) and copolymers, by themselves or in blends. Poly(trimethylene terephthalate)s used in the invention preferably contain about 70 mole % or more of repeat units derived from 1,3-propane diol and terephthalic acid (and/or an equivalent thereof, such as dimethyl terephthalate).

The poly(trimethylene terephthalate) may contain up to 30 mole % of repeat units made from other diols or diacids. The other diacids include, for example, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. The other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides.

More preferably, the poly(trimethylene terephthalate)s contain at least about 80 mole %, or at least about 90 mole %, or at least about 95 mole %, or at least about 99 mole %, of repeat units derived from 1,3-propane diol and terephthalic acid (or equivalent). The most preferred polymer is poly(trimethylene terephthalate) homopolymer (polymer of substantially only 1,3-propane diol and terephthalic acid or equivalent).

### Additive Package

The poly(trimethylene terephthalate)-based compositions of the present invention may contain additives such as antioxidants, residual catalyst, delusterants (such as TiO₂, zinc sulfide or zinc oxide), colorants (such as dyes), stabilizers, fillers (such as calcium carbonate), antimicrobial agents, antistatic agents, optical brighteners, extenders, processing aids and other functional additives, hereinafter referred to as “chip additives”. When used, TiO₂ or similar compounds (such as zinc sulfide and zinc oxide) are used as pigments or delusterants in amounts normally used in making poly(trimethylene terephthalate) compositions, that is up to about 5 wt % or more (based on total composition weight) in making fibers and larger amounts in some other end uses.

By “pigment” reference is made to those substances commonly referred to as pigments in the art. Pigments are substances, usually in the form of a dry powder, that impart color to the polymer or article (e.g., chip or fiber). Pigments can be inorganic or organic, and can be natural or synthetic. Generally, pigments are inert (e.g., electronically neutral and do not react with the polymer) and are insoluble or relatively insoluble in the medium to which they are added, in this case the poly(trimethylene terephthalate) composition. In some instances they can be soluble. Pigments are typically added as a masterbatch compound at levels of between about 2 and 3 weight percent, based on the total weight of the poly(trimethylene terephthalate)-based polymer.

Low concentrations of additives (0-5%) have not been found to positively impact part whitening. Part whitening has also been observed in glass reinforced parts. The methods covered in the present disclosure can be applied to PTT parts containing these additive packages.

The poly(trimethylene terephthalate)-based compositions of the invention may be prepared by conventional blending techniques well known to those skilled in the art, e.g. compounding in a polymer extruder, melt blending, etc.

The polymer component and additive(s) can be melt blended. More specifically they can be mixed and heated at a temperature sufficient to form a melt blend, and formed into shaped articles. The ingredients can be formed into a blended composition in many different ways. For instance, they can be (a) heated and mixed simultaneously, (b) pre-mixed in a separate apparatus before heating, or (c) heated and then mixed. The mixing, heating and forming can be carried out by conventional equipment designed for that purpose such as extruders, Banbury mixers or the like. The temperature should be above the melting points of each component but below the lowest decomposition temperature, and accordingly must be adjusted for any particular composition of PTT and flame retardant additive. The temperature is typically in the range of about 230° C. to about 300° C.

In the present invention, poly(trimethylene terephthalate) (PTT) is blended with other polymers, including, for example, poly(ethylene terephthalate) (PET), poly(butylene terephthalate) (PBT), and poly(lactic acid) (PLA), or mixtures thereof. The blend polymers are generally condensation polymers. Generally, PTT is present in amounts ranging from 0 to 100 percent, based on the percent condensation polymer(s) and excluding any other polymer, pigment and additives in the mixture. Note that condensation polymer(s) may be PTT and blend polymer(s); or PTT. The blend polymers are present in amounts ranging from 9 to 98 percent, based on the percent condensation polymer in a mixture excluding any other polymer, pigment and other additives in the mixture. After compounding as described herein, the PTT and the polymer blends are subjected to an elevated-temperature bloom test, and the resultant color/whiteness, present due to the cyclic oligomer bloom, is measured as described.

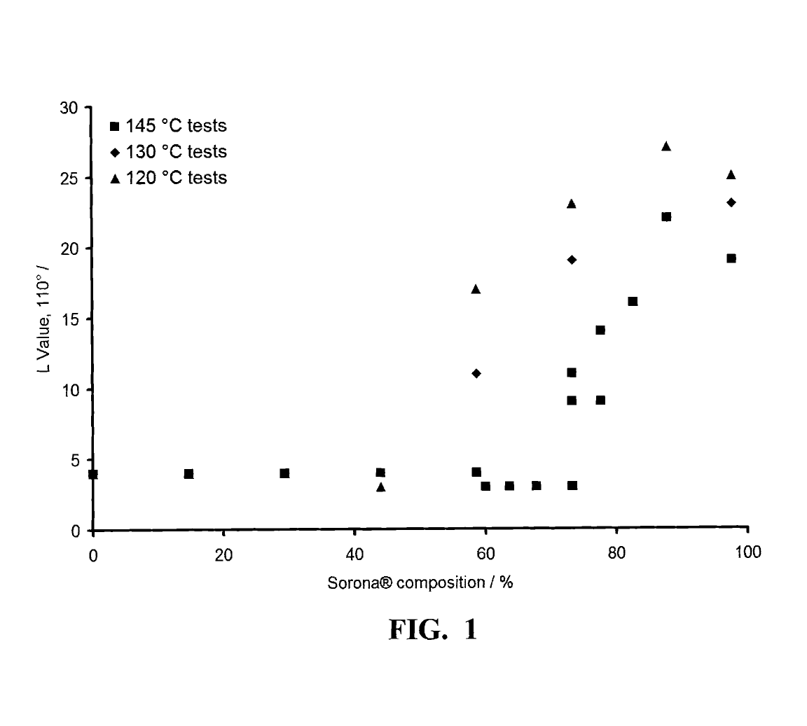

As shown in Table 1 and FIG. 1, plaques aged at 120° C. showed whitening in lower PTT compositions when compared to plaques aged at higher temperatures. In order to get good whitening performance at all temperatures tested, PTT blends containing 0-44 wt. % PTT, typically 9-44% PTT is preferred for color-critical end-uses, such as automotive parts and films, as the L* at 110° (from the specular beam (see U.S. Pat. No. 4,479,718)) is typically less than 5 units. Compositions having higher percentages of PTT may exhibit levels of whitening acceptable for less critical end-uses, such as painted automotive parts or batch died fibers when tested at various temperatures,

Poly(trimethylene terephthalate)s useful as the polyester in this invention are commercially available from E. I. DuPont de Nemours and Company of Wilmington, Del. under the trademark Sorona® and from Shell Chemicals of Houston, Tex. under the trademark Corterra®. All other polymers disclosed herein are considered to be “blend polymers”.

The PTT polymer used in the Examples below was Sorona® Bright polymer. All PBT polymer used was Crastin® PBT (poly(butylene terephthalate)) polyester polymer available from E. I. DuPont de Nemours and Company of Wilmington, Del. All PET polymer was Voridian™ PET F80CC (poly(ethylene terephthalate)) polymer available from Eastman Chemical Co., Kingsport, Tenn. All PLA (polylactic acid) polymer was PLA Lactron 800DA/RF, available from Kanebo Kabushiki Kaisha, Tokyo, Japan.

### Examples

The PTT blends in the Examples below were prepared in a twin screw extruder compounding the polymer with various levels of blend polymers in addition to 2.30% carbon black masterbatch. The compounded pellets were subsequently dried at 120° C. for 12 hours and molded into 3″×5″×⅛″ plaques. Plaques were then evaluated for blooming using an elevated temperature aging test. For this test, plaques were wrapped in aluminum foil and placed in aluminum pans to provide uniform heating throughout the part. The wrapped plaques in aluminum pans were placed in a closed oven (no vacuum/purge) for various times at elevated temperatures. Part blooming can be observed over a range of temperatures including 145° C. for 24 hours, 130° C. for 120 hours and 120° C. for 96 hours. Part blooming was quantified using a DuPont Color Solutions X-Rite L*a*b* colorimeter since the white cyclic oligomer bloom covers the surface of a black part. The smaller the amount of cyclic oligomer is on the surface, the more the carbon black pigment can be observed by incident light. Observations made for the L* value on the 110° angle gave a quantitative measure of blooming that agrees well with a visual rating system. Low L* values (3-5) correspond to a low degree of blooming and higher L* values (20-25) correspond to a high degree of blooming.

A summary of results for the Examples below is found in Table 1. A graphical representation of the L value versus the amount of poly(trimethylene terephthalate) in the material tested is shown in FIG. 1.

### Example 1

A polymer was prepared in a twin screw extruder compounding 97.70% PTT polymer with in addition to 2.30% carbon black masterbatch (52.5 weight % polyethylene carrier, 47.5 weight % carbon black). The samples were compounded as described above. The compounded pellets were subsequently dried at 120° C. for 12 hours and molded into 3″×5″×⅛″ plaques as described above. Plaques were then evaluated for blooming using the blooming test as described above. The wrapped plaque in an aluminum pan was placed in a closed oven (no vacuum/purge) for 24 hours at 145° C.

### Example 2

A plaque of identical composition of Example 1 aged in an elevated-temperature blooming test in a closed oven (no vacuum/purge) at 130° C. for 120 hours.

### Example 3

A plaque of identical composition of Example 1 aged in an elevated-temperature blooming test in a closed oven (no vacuum/purge) at 120° C. for 96 hours.

### Example 4

A polymer prepared similarly to the polymer described in Example 1, except a blend of PTT (87.93%) and PBT (9.77%) was used in addition to 2.30% carbon black masterbatch. A plaque of this composition was aged in an elevated-temperature blooming test in a closed oven (no vacuum/purge) at 145° C. for 24 hours.

### Example 5

A plaque of identical composition of Example 4 aged in an elevated-temperature blooming test in a closed oven (no vacuum/purge) at 130° C. for 120 hours.

### Example 6

A plaque of identical composition of Example 4 aged in an elevated-temperature blooming test in a closed oven (no vacuum/purge) at 120° C. for 96 hours.

### Example 7

A polymer prepared similarly to the polymer described in Example 1, except a blend of PTT (73.28%) and PBT (24.43%) was used in addition to 2.30% carbon black masterbatch. A plaque of this composition was aged in an elevated-temperature blooming test in a closed oven (no vacuum/purge) at 145° C. for 24 hours.

### Example 8

A plaque of identical composition of Example 7 aged in an elevated-temperature blooming test in a closed oven (no vacuum/purge) at 130° C. for 120 hours.

### Example 9

A plaque of identical composition of Example 7 aged in an elevated-temperature blooming test in a closed oven (no vacuum/purge) at 120° C. for 96 hours.

### Example 10

A polymer prepared similarly to the polymer described in Example 1, except a blend of PTT (58.62%) and PBT (39.08%) was used in addition to 2.30% carbon black masterbatch. A plaque of this composition was aged in an elevated-temperature blooming test in a closed oven (no vacuum/purge) at 145° C. for 24 hours.

### Example 11

A plaque of identical composition of Example 10 aged in an elevated-temperature blooming test in a closed oven (no vacuum/purge) at 130° C. for 120 hours.

### Example 12

A plaque of identical composition of Example 10 aged in an elevated-temperature blooming test in a closed oven (no vacuum/purge) at 120° C. for 96 hours.

### Example 13

A polymer prepared similarly to the polymer described in Example 1, except a blend of PTT (43.97%) and PBT (53.74%) was used in addition to 2.30% carbon black masterbatch. A plaque of this composition was aged in an elevated-temperature blooming test in a closed oven (no vacuum/purge) at 145° C. for 24 hours.

### Example 14

A plaque of identical composition of Example 13 aged in an elevated-temperature blooming test in a closed oven (no vacuum/purge) at 130° C. for 120 hours.

### Example 15

A plaque of identical composition of Example 13 aged in an elevated-temperature blooming test in a closed oven (no vacuum/purge) at 120° C. for 96 hours.

### Example 16

A polymer prepared similarly to the polymer described in Example 1, except a blend of PTT (29.31%) and PBT (68.39%) was used in addition to 2.30% carbon black masterbatch. A plaque of this composition was aged in an elevated-temperature blooming test in a closed oven (no vacuum/purge) at 145° C. for 24 hours.

### Example 17

A plaque of identical composition of Example 16 aged in an elevated-temperature blooming test in a closed oven (no vacuum/purge) at 130° C. for 120 hours.

### Example 18

A plaque of identical composition of Example 16 aged in an elevated-temperature blooming test in a closed oven (no vacuum/purge) at 120° C. for 96 hours.

### Example 19

A polymer prepared similarly to the polymer described in Example 1, except a blend of PTT (14.66%) and PBT (83.05%) was used in addition to 2.30% carbon black masterbatch. A plaque of this composition was aged in an elevated-temperature blooming test in a closed oven (no vacuum/purge) at 145° C. for 24 hours.

### Example 20

A plaque of identical composition of Example 19 aged in an elevated-temperature blooming test in a closed oven (no vacuum/purge) at 130° C. for 120 hours.

### Example 21

A plaque of identical composition of Example 19 aged in an elevated-temperature blooming test in a closed oven (no vacuum/purge) at 120° C. for 96 hours.

### Example 22

A polymer prepared similarly to the polymer described in Example 1, except 97.70% PBT polymer was used in addition to 2.30% carbon black masterbatch. A plaque of this composition was aged in an elevated-temperature blooming test in a closed oven (no vacuum/purge) at 145° C. for 24 hours.

### Example 23

A plaque of identical composition of Example 22 aged in an elevated-temperature blooming test in a closed oven (no vacuum/purge) at 130° C. for 120 hours.

### Example 24

A plaque of identical composition of Example 22 aged in an elevated-temperature blooming test in a closed oven (no vacuum/purge) at 120° C. for 96 hours.

### Example 25

A polymer prepared similarly to the polymer described in Example 1, except a blend of PTT (60.00%) and PBT (37.70%) was used in addition to 2.30% carbon black masterbatch. A plaque of this composition was aged in an elevated-temperature blooming test in a closed oven (no vacuum/purge) at 145° C. for 24 hours.

### Example 26

A polymer prepared similarly to the polymer described in Example 1, except a blend of PTT (63.70%) and PBT (34.00%) was used in addition to 2.30% carbon black masterbatch. A plaque of this composition was aged in an elevated-temperature blooming test in a closed oven (no vacuum/purge) at 145° C. for 24 hours.

### Example 27

A polymer prepared similarly to the polymer described in Example 1, except a blend of PTT (67.70%) and PBT (30.00%) was used in addition to 2.30% carbon black masterbatch. A plaque of this composition was aged in an elevated-temperature blooming test in a closed oven (no vacuum/purge) at 145° C. for 24 hours.

### Example 28

A polymer prepared similarly to the polymer described in Example 1, except a blend of PTT (73.20%) and PBT (24.50%) was used in addition to 2.30% carbon black masterbatch. A plaque of this composition was aged in an elevated-temperature blooming test in a closed oven (no vacuum/purge) at 145° C. for 24 hours.

### Example 29

A polymer prepared similarly to the polymer described in Example 1, except a blend of PTT (77.70%) and PBT (20.00%) was used in addition to 2.30% carbon black masterbatch. A plaque of this composition was aged in an elevated-temperature blooming test in a closed oven (no vacuum/purge) at 145° C. for 24 hours.

### Example 30

A polymer prepared similarly to the polymer described in Example 1, except a blend of PTT (67.70%) and PET (30.00%) was used in addition to 2.30% carbon black masterbatch. A plaque of this composition was aged in an elevated-temperature blooming test in a closed oven (no vacuum/purge) at 145° C. for 24 hours.

### Example 31

A polymer prepared similarly to the polymer described in Example 1, except a blend of PTT (77.70%) and PET (20.00%) was used in addition to 2.30% carbon black masterbatch. A plaque of this composition was aged in an elevated-temperature blooming test in a closed oven (no vacuum/purge) at 145° C. for 24 hours.

### Example 32

A polymer prepared similarly to the polymer described in Example 1, except a blend of PTT (73.20%) and PET (24.50%) was used in addition to 2.30% carbon black masterbatch. A plaque of this composition was aged in an elevated-temperature blooming test in a closed oven (no vacuum/purge) at 145° C. for 24 hours.

### Example 33

A polymer prepared similarly to the polymer described in Example 1, except a blend of PTT (82.70%) and PET (15.00%) was used in addition to 2.30% carbon black masterbatch. A plaque of this composition was aged in an elevated-temperature blooming test in a closed oven (no vacuum/purge) at 145° C. for 24 hours.

### Example 34

A polymer prepared similarly to the polymer described in Example 1, except a blend of PTT (73.20%), PBT (14.50%), and PLA (10.00%) was used in addition to 2.30% carbon black masterbatch. A plaque of this composition was aged in an elevated-temperature blooming test in a closed oven (no vacuum/purge) at 145° C. for 24 hours.

### Example 35

A polymer prepared similarly to the polymer described in Example 1, except a blend of PTT (73.20%), PBT (10.00%), and PLA (14.50%) was used in addition to 2.30% carbon black masterbatch. A plaque of this composition was aged in an elevated-temperature blooming test in a closed oven (no vacuum/purge) at 145° C. for 24 hours.

TABLE 1

| | | | | 145° C. | | 130° C. | | 120° C. | |
|---|---|---|---|---|---|---|---|---|---|
| | % Carbon | | % Blend Polymer | % | | % | | % | |
| Example # | Masterbatch | Blend Polymer | Added | 3GT | L* Value 110° | 3GT | L* Value 110° | 3GT | L* Value 110° |
| 1 | 2.30 | none | 0.00 | 97.70 | 19 | | | | |
| 2 | 2.30 | none | 0.00 | | | 97.70 | 23 | | |
| 3 | 2.30 | none | 0.00 | | | | | 97.70 | 25 |
| 4 | 2.30 | PBT | 9.77 | 87.93 | 22 | | | | |
| 5 | 2.30 | PBT | 9.77 | | | 87.93 | 22 | | |
| 6 | 2.30 | PBT | 9.77 | | | | | 87.93 | 27 |
| 7 | 2.30 | PBT | 24.43 | 73.28 | 3 | | | | |
| 8 | 2.30 | PBT | 24.43 | | | 73.28 | 19 | | |
| 9 | 2.30 | PBT | 24.43 | | | | | 73.28 | 23 |
| 10 | 2.30 | PBT | 39.08 | 58.62 | 4 | | | | |
| 11 | 2.30 | PBT | 39.08 | | | 58.62 | 11 | | |
| 12 | 2.30 | PBT | 39.08 | | | | | 58.62 | 17 |
| 13 | 2.30 | PBT | 53.74 | 43.97 | 4 | | | | |
| 14 | 2.30 | PBT | 53.74 | | | 43.97 | 4 | | |
| 15 | 2.30 | PBT | 53.74 | | | | | 43.97 | 3 |
| 16 | 2.30 | PBT | 68.39 | 29.31 | 4 | | | | |
| 17 | 2.30 | PBT | 68.39 | | | 29.31 | 4 | | |
| 18 | 2.30 | PBT | 68.39 | | | | | 29.31 | 4 |
| 19 | 2.30 | PBT | 83.05 | 14.66 | 4 | | | | |
| 20 | 2.30 | PBT | 83.05 | | | 14.66 | 4 | | |
| 21 | 2.30 | PBT | 83.05 | | | | | 14.66 | 4 |
| 22 | 2.30 | PBT | 97.70 | 0 | 4 | | | | |
| 23 | 2.30 | PBT | 97.70 | | | 0.00 | 4 | | |
| 24 | 2.30 | PBT | 97.70 | | | | | 0.00 | 4 |
| 25 | 2.30 | PBT | 37.70 | 60.00 | 3 | | | | |
| 26 | 2.30 | PBT | 34.00 | 63.70 | 3 | | | | |
| 27 | 2.30 | PBT | 30 | 67.70 | 3 | | | | |
| 28 | 2.30 | PBT | 24.50 | 73.20 | 3 | | | | |
| 29 | 2.30 | PBT | 20.00 | 77.70 | 9 | | | | |
| 30 | 2.30 | PET | 30.00 | 67.70 | 3 | | | | |
| 31 | 2.30 | PET | 20.00 | 77.70 | 14 | | | | |
| 32 | 2.30 | PET | 24.50 | 73.20 | 9 | | | | |
| 33 | 2.30 | PET | 15.00 | 82.70 | 16 | | | | |
| 34 | 2.30 | PBT/PLA | 14.50/10.00 | 73.20 | 9 | | | | |
| 35 | 2.30 | PBT/PLA | 10.00/14.50 | 73.20 | 11 | | | | |

What is claimed is:

1. A process for producing reduced-whitening poly(trimethylene terephthalate)-based polymers, comprising:
combining poly(trimethylene terephthalate) with one or more blend polymer(s); and
optionally adding one or more pigments;
optionally one or more additives; and
wherein the poly(trimethylene terephthalate) with one or more blend polymer(s) exhibits whitening at levels below that of poly(trimethylene terephthalate) when subjected to an elevated temperature aging test.

2. The process of claim 1, wherein said blend polymer(s) are selected from the group consisting of poly(butylene terephthalate), poly(ethylene terephthalate), poly(lactic acid) and mixtures thereof.

3. The process of claim 2, wherein poly(trimethylene terephthalate) is present at a concentration of 9 to 44 weight percent based on the percent blend polymer(s) and poly(trimethylene terephthalate).

4. The process of claim 1, wherein said pigment is added as a masterbatch compound at levels between about 2 and 3 weight percent, based on the total weight of the poly(trimethylene terephthalate)and blend polymer(s).

5. The process of claim 4, wherein said pigment is carbon black.

6. The process of claim 1, wherein said poly(trimethylene terephthalate), said blend polymer(s) and optionally said pigment are combined by extrusion.

7. A process for determining L* whiteness of a polymer part comprising poly(trimethylene terephthalate), comprising
a. combining poly(trimethylene terephthalate) with one or more blend polymers;
b. optionally adding one or more pigments;
c. forming a part from said polymer blend;
d. exposing said part to an elevated temperature source at temperatures greater than 100 degrees C. for a period of time of 24 hours or greater;
e. measuring said L* whiteness of said polymer part.

8. The process of claim 7, wherein said blend polymer is selected from the group consisting of poly(butylene terephthalate), poly(ethylene terephthalate), poly(lactic acid), and mixtures thereof.

9. The process of claim 7, wherein said pigment(s) is added via a masterbatch compound.

10. The process of claim 7, wherein said exposure to elevated temperatures occurs within a closed oven.

11. The process of claim 7, wherein said measured L* whiteness is less than 7 units after an elevated temperature aging test.

12. The process of claim 1 wherein the additives are selected from the group consisting of glass fiber and chip additives.
